(19) United States
(12) Patent Application Publication
(10) Pub. No.: US 2020/0296475 A1
(43) Pub. Date: Sep. 17, 2020

(54) INFORMATION PROCESSING DEVICE, INFORMATION PROCESSING METHOD, AND INFORMATION PROCESSING SYSTEM

(71) Applicant: SONY CORPORATION, TOKYO (JP)

(72) Inventors: SATOSHI MIYAZAKI, KANAGAWA (JP); GEN ICHIMURA, TOKYO (JP); KAZUAKI TOBA, KANAGAWA (JP); KAZUO YAMAMOTO, CHIBA (JP)

(21) Appl. No.: 16/756,521

(22) PCT Filed: Sep. 3, 2018
(86) PCT No.: PCT/JP2018/032620

§ 371 Date: Apr. 16, 2020

(30) Foreign Application Priority Data
Oct. 25, 2017 (JP) 2017-205768

(51) Int. Cl. H04N 21/647; H04N 21/4363; H04N 21/643

(52) U.S. Cl. CPC H04N 21/64707; H04N 21/64322; H04N 21/4363

(57) ABSTRACT

An information processing device includes a first communication section, a second communication section, and a processing section. The first communication section is configured to perform communication using an IP. The second communication section is configured to perform communication using a non-IP wired interface. The processing section is configured to communicate a control command using one of the first communication section and the second communication section according to a specified condition, the first communication section being used to communicate an IP control command that is the control command using the IP, the second communication section being used to communicate a wire control command that is the control command with respect to a communication using the wired interface.

### TECHNICAL FIELD

The present technology relates to an information processing system that includes a plurality of information processing devices building a network, the information processing devices, and an information processing method.

### BACKGROUND ART

High Definition Multimedia Interface (registered trademark, and the same applies hereinafter) has been widely used as a communication interface that performs a high-speed transmission of uncompressed (baseband) audio visual (AV) data from a recorder, a set-top box, or other AV sources to a television set (TV) or other displays (for example, refer to Patent Literature 1).

### CITATION LIST

### Patent Literature

Patent Literature 1: Japanese Patent Application Laid-open No. 2009-010537

### DISCLOSURE OF INVENTION

### Technical Problem

In recent years, a network has been increasingly built with a plurality of devices in a house, using an Internet protocol (IP) connection. In such a case, one device includes a control system using a wired network of, for example, HDMI, and a control system using an IP. In a state in which these control systems coexist, an appropriate operation of each device is not ensured, or there is a need to perform a complicated process of avoiding a conflict between control commands.

An object of the present disclosure is to provide an information processing device, an information processing method, and an information processing system that make it possible to easily avoid a conflict between a control system using an IP and a control system with respect to a communication using a wired interface.

### Solution to Problem

An information processing device according to an embodiment includes a first communication section, a second communication section, and a processing section.

The first communication section is configured to perform communication using an IP.

The second communication section is configured to perform communication using a non-IP wired interface.

The processing section is configured to communicate a control command using one of the first communication section and the second communication section according to a specified condition, the first communication section being used to communicate an IP control command that is the control command using the IP, the second communication section being used to communicate a wire control command that is the control command with respect to a communication using the wired interface.

In the information processing device, the selection of one of a communication using the first communication section and a communication using the second communication section makes it possible to easily avoid a conflict between a control system using an IP and a control system with respect to a communication using a non-IP wired interface.

The processing section may be configured to stop the communication performed using the second communication section when the processing section determines whether a second information processing device is able to receive the wire control command using the first communication section included in the second information processing device and has determined that the second information processing device is able to receive the wire control command using the first communication section included in the second information processing device, the second information processing device being connected to the information processing device through a wired network using the wired interface.

The processing section may be configured to convert the wire control command into the IP control command, and to transmit, using the first communication section, the IP control command obtained by the conversion.

The information processing device can communicate the IP control command to the second information processing device using the IP even if the communication of the wire control command is stopped.

The processing section may be configured to determine, in a state in which the communication of the wire control command that is performed using the second communication section has been stopped, whether a restart of the communication of the wire control command is possible. This makes it possible to restart performing communication using the wired interface depending on a condition.

The processing section may be configured to communicate a control command using one of a communication performed using the first communication section and a communication performed using the second communication section, the one of the communications being selected by a user, the control command corresponding to the selected communication.

The first communication section may be configured to receive the IP control command issued by a controller that is connected to an IP network using the IP.

The information processing device may further include a command generator configured to generate the wire control command.

The command generator may be configured to generate the wire control command according to a non-IP command issued by a remote controller.

The second communication section may be configured to receive the wire control command issued by a third information processing device that is an information processing device other than the second information processing device.

Accordingly, the information processing device can build a news cluster structure of a wired network that includes a third information processing device, and can expand (increase) a device to be controlled by the wired interface.

The processing section may be configured to transmit the received wire control command to the second information processing device using one of the first communication section and the second communication section.

This makes it possible to establish an operation linkage among three or more devices after one of the first communication section and the second communication section is selected.

The second communication section may be configured to transmit or receive an audio visual (AV) stream as primary data.

An information processing method according to an embodiment is a method that is performed by an information processing device that includes a first communication section configured to perform communication using an IP, and a second communication section configured to perform communication using a non-IP wired interface.

According to a specified condition, a control command is communicated using one of the first communication section and the second communication section, the first communication section being used to communicate an IP control command that is the control command using the IP, the second communication section being used to communicate a wire control command that is the control command with respect to a communication using the wired interface.

An information processing system according to an embodiment includes a first information processing device and a second information processing device.

The second information processing device is capable of communicating the first information processing device using an IP and is connected to the first information processing device through a wired network using a non-IP wired interface.

The first information processing device includes a first communication section configured to perform communication using the IP, and a second communication section configured to perform communication using the wired interface.

The first information processing device further includes a processing section. The processing section is configured to communicate a control command using one of the first communication section and the second communication section according to a specified condition, the first communication section being used to communicate an IP control command that is the control command using the IP, the second communication section being used to communicate a wire control command that is the control command with respect to a communication using the wired interface.

### Advantageous Effects of Invention

As described above, the present technology makes it possible to easily avoid a conflict between a control system using an IP and a control system with respect to a communication using a wired interface.

Note that the effects described herein are not necessarily limitative and may be any effect described in the present disclosure.

### BRIEF DESCRIPTION OF DRAWINGS

FIG. 1 is a block diagram of a configuration of an information processing system according to an embodiment of the present technology.

FIG. 2 is a block diagram of a configuration of a device that can perform an IP communication and a non-IP wired communication.

FIG. 3 is a flowchart of a basic operation of the device illustrated in FIG. 2.

FIG. 4 is a flowchart of a more specific example of the operation of the device illustrated in FIG. 2.

FIGS. 5A and 5B illustrate an effect provided by stopping a function of communication by use of CEC on an HDMI cable.

FIG. 6 is a block diagram of a typical example of the information processing system illustrated in FIG. 1.

FIG. 7 is a sequence diagram of an operation performed when a function of One Touch Play has been applied to the present technology.

### MODE(S) FOR CARRYING OUT THE INVENTION

Embodiments according to the present technology will now be described below with reference to the drawings.

### 1. Configuration of Information Processing System

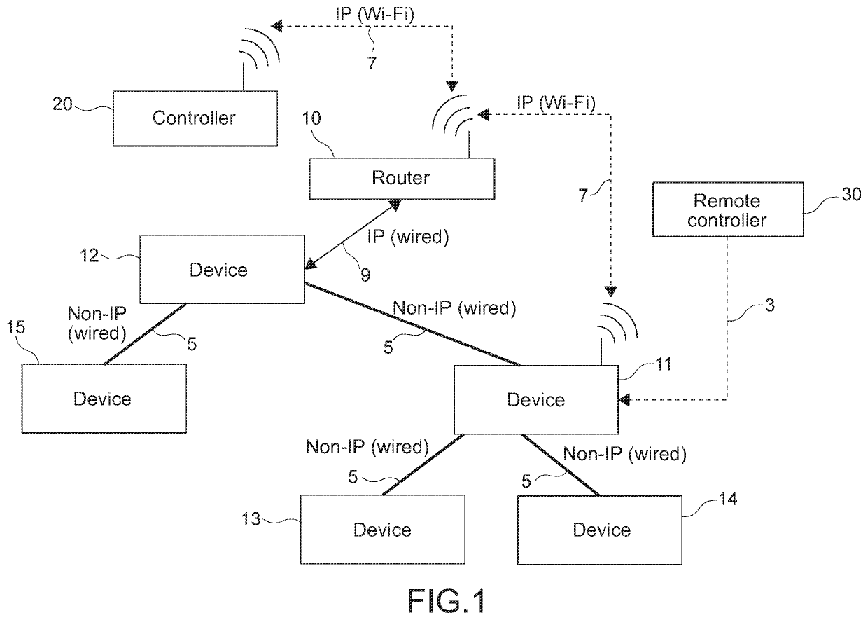

FIG. 1 is a block diagram of a configuration of an information processing system according to an embodiment of the present technology. The information processing system includes, for example, five devices 11 to 15, a router 10, a controller 20, and a remote controller 30. An IP network and a non-IP wired network coexist in the information processing system.

The devices 11 to 15 are connected to the non-IP wired network, and specifically, the devices 11 to 15 are connected to one another through cables 5 each connected to a wired interface (hereinafter referred to as a wired IF). For example, HDMI or Syndicat des Constructeurs d'Appareils Radiorécepteurs et Téléviseurs (SCART) is used as the wired IF.

From among the devices 11 to 15, the devices 11 and 12 can also perform communication using an IP. The devices 13 to 15 do not support an IP. As described later, the devices 11 to 15 are home electric devices such as a TV, an amplifier, and a playback device.

The controller 20 and the devices 11 and 12 form an IP network through the router 10. Specifically, the device 11 and the controller 20 are connected to the router 10 through, for example, a wireless local area network (LAN) using Wi-Fi. The device 12 is connected to the router 10 through, for example, a LAN cable 9.

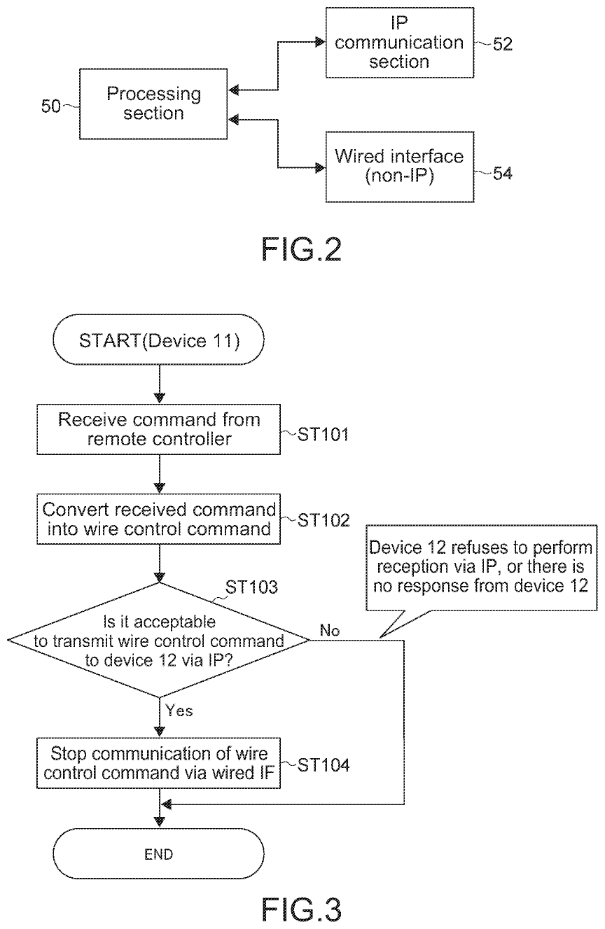

FIG. 2 is a block diagram of a configuration of the device 11 (or 12). The device 11 (or 12) includes a processing section 50, an IP communication section 52, and a wired IF 54.

The processing section 50 primarily includes basic hardware for a computer such as a CPU, a RAM, and a ROM, and the ROM stores therein a necessary program. The IP communication section 52 is a communication module that can perform communication using an IP, and serves as a “first communication section”. A communication function of the wired IF 54 serves as a “second communication section”.

The controller 20 is a control device used in, for example, a home automation system or a smart home system, and remotely controls the devices 11 and 12 connected to an IP network. The controller 20 is operated by a user, and is configured to generate a control command (an IP control command described later) depending on an input of the operation. A device that uses Control4 is a typical example of the controller 20.

The remote controller 30 is a device that is configured to issue a non-IP command such as a command that uses, for example, an infrared ray 3. The device 11 can receive the command.

Note that the device 11 serves as an information processing device (a first information processing device), and the device 12 serves as a second information processing device. A device other than the devices 11 and 12 that is connected to a wired network (for example, the devices 13 to 15) serves as a third information processing device.

In the information processing device having such a configuration, the processing section 50 of the device 11 or 12 selects one of a control system using an IP and a control system using the wired IF 54 according to a specified condition, and performs a communication of a control command depending on the selected control system.

The device 11 or 12 uses a control command based on an IP when an IP control system is selected. On the other hand, the device 11 or 12 uses a control command based on the standards of the wired IF 54 when a control system of the wired IF 54 is selected. For convenience, the control command based on an IP is hereinafter referred to as an “IP control command”. For convenience, the control command based on the standards of the wired IF 54 is hereinafter referred to as a “wire control command”.

When the wired IF 54 is, for example, HDMI, a command using, for example, Consumer Electronics Control (CEC) is an example of the wire control command.

Note that HDMI provides a control between devices by using a physical address and a logical address as described later and communicating a control command using the CEC line described above in the cable 5.

As described above, the device 11 or 12 can easily avoid a conflict between a control system using an IP and a control system based on the standards of a non-IP wired IF by selecting one of the IP communication section 52 and the wired IF 45.

### 2. Operation of Information Processing System

### 2.1) Operation Example 1

FIG. 3 is a flowchart of a basic operation of the device 11 in the information processing system. The device 11 receives a command from the remote controller 30 via the infrared ray 3 (Step (hereinafter referred to as ST) 101). The device 11 generates a wire control command according to the received command (converts the received command into a wire control command) (ST102). In this case, the processing section 50 of the device 11 serves as a “command generator”.

The device 11 determines whether the device 12 can receive the wire control command via IP (via the IP communication section 52) (ST103). Specifically, it is sufficient if, for example, the device 11 inquires of the device 12 whether it is acceptable to transmit the wire control command to the device 12 via IP (whether the device 12 can receive the wire control command via IP). This inquiry is performed, for example, via the wired IF (54). Information regarding a result of the determination performed in ST103 corresponds to the “specified condition” described above.

When it has been determined to be Yes in ST103, that is, when the device 11 receives, from the device 12, a response indicating that it is acceptable to transmit the wire control command via IP, the device 11 stops a function of communicating a wire control command via a wired IF (ST104). The response from the device 12 is performed, for example, via a wired IF. After that, the device 11 and the device 12 perform transmission and reception of a wire control command via IP.

A conflict between an IP control command and a wire control command is avoided since the function of communicating a wire control command is stopped.

Note that the device 11 (or 12) only stops a communication function for a system in the wired IF 54, and a communication of an AV stream that is primary data, and of other data is not stopped. For example, when the wired IF 54 is HDMI, a communication using CEC is stopped, but a communication using other channels in HDMI, such as a transition minimized differential signaling (TMDS) channel, is not stopped.

On the other hand, when it has been determined to be No in ST103, that is, when the device 12 refuses to receive (or is not able to receive) a wire control command via IP, or when there is no response from the device 12, the operation of the device 11 is terminated at this point.

When it has been determined to be Yes in ST103, for example, the controller 20, or the device 11 or 12 may inquire of a user about the content of ST104 (whether it is acceptable to stop a communication of a wire control command via a wired IF) (a pattern of selection performed by a user). Information regarding a result of the inquiry corresponds to the “specified condition” described above. In this case, it is sufficient if, for example, the devices 11 and 12 mutually confirm, in ST103 and via IP, whether the devices 11 and 12 are capable of dealing with a wire control command, and then report to the controller 20 via IP. Then, using a UI included in the controller 20, the controller 20 inquires of the user whether it is acceptable to stop a communication of a wire control command via a wired IF. It is sufficient if, for example, Universal Plug and Play (UPnP) is used for the communication via IP.

### 2.2) Operation Example 2

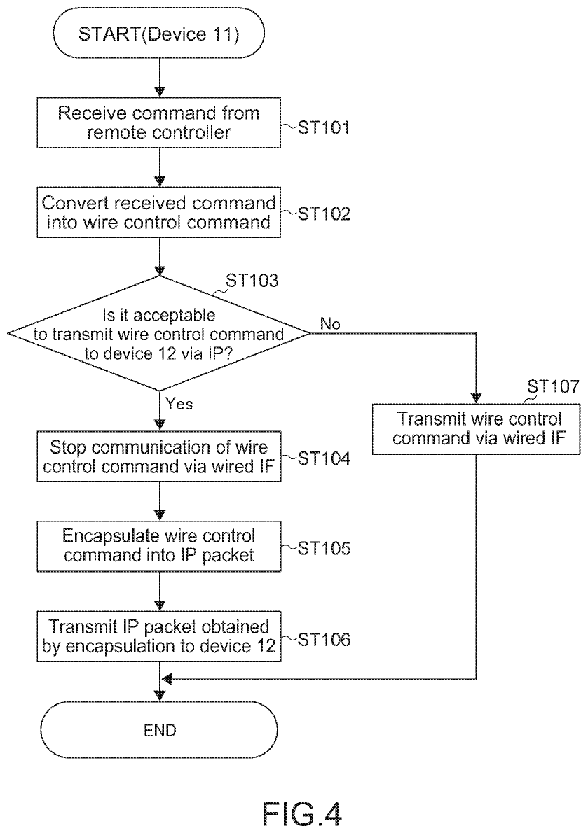

FIG. 4 is a flowchart of a more specific example of the operation of the device 11. In FIG. 4, a description of a process identical to that in FIG. 3 is omitted. After ST104, the device 11 encapsulates the wire control command into an IP packet (ST105). In other word, the device 11 converts the wire control command into an IP control command.

A method for encapsulating a wire control command into a packet on UPnP is an example of the method for encapsulating a wire control command. Of course, a packetizing method other than the packetizing method using UPnP described above is also applicable to the present technology.

The device 11 transmits the IP packet obtained by the encapsulation to the device 12 (via IP) (ST106).

When it has been determined to be No in ST103, the device 11 transmits the wire control command to the device 12 via a wired IF (ST107).

### 3. Effects

The present technology provides the following effects when HDMI is used as the wired IF 54 and a CEC command is used as the wire control command.

By performing control using CEC over IP, the devices 11 and 12 can perform, as usual and using CEC over IP, an activation of Audio Return Channel (ARC) that is being currently performed on CEC, a control of System Audio Mode, and the like. Further, this makes it possible to easily avoid a conflict with an IP control command connected in the same network.

Although the transfer rate of CEC using an HDMI cable is a rate low of hundreds of bps, the transfer rate of CEC increases dramatically up to dozens to hundreds of Mbps by CEC being implemented over IP. This results in being able to solve a problem such as bus congestion on CEC in addition to the avoidance of a command conflict.

Further, the present technology provides another effect of being able to introduce a new configuration into an HDMI cluster by stopping a function of communication by use of CEC on an HDMI cable. In other words, devices in which a communication using CEC is stopped each become a new root of an HDMI cluster, and it is possible to divide and expand the cluster.

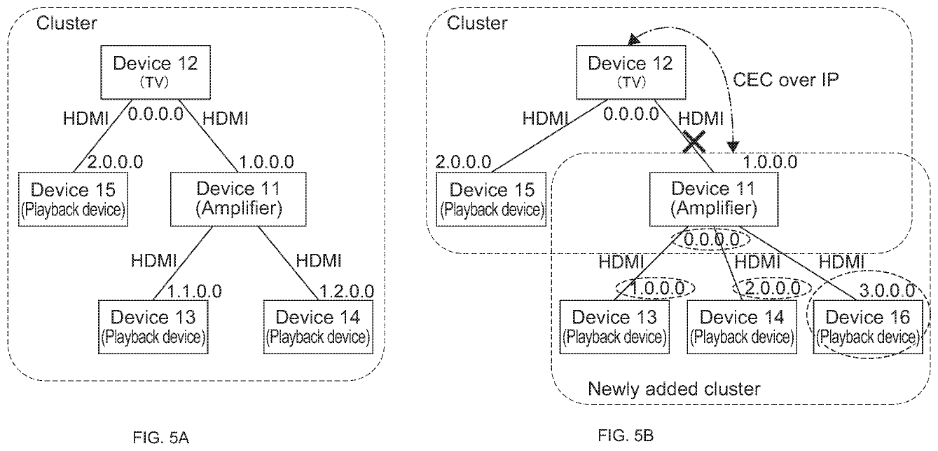

FIGS. 5A and 5B illustrate an effect provided by stopping a function of communication by use of CEC on an HDMI cable. As illustrated in FIG. 5A, before the CEC communication between the devices 11 and 12 is stopped, there exists a single HDMI cluster, with the device 12 being a root. As illustrated in FIG. 5B, in addition to the device 12, the device 11 can also be considered a root by the CEC communication being stopped, and thus two clusters can be built.

In HDMI, the number of devices allowed to be connected in a single cluster is determined for each type of device. The restriction on the number of devises is alleviated by stopping a CEC communication and by dividing and expanding a cluster. This results in being able to newly add a device to an HDMI network and to expand a device to be controlled.

An effect provided when, for example, the device 12 is a TV, the device 11 is an amplifier, and the devices 13 to 15 are, for example, playback devices that play back media, is specifically described.

In FIG. 5A, 0.0.0.0 is assigned to a TV as a physical address that is defined in HDMI, and the TV that is the device 12 is a root. The physical address is a uniquely determined address that represents a form of a connection of a device in an HDMI network. An amplifier to which a physical address of 1.0.0.0 is assigned is connected to the TV. In other words, a single HDMI cluster is built with the TV being a root.

In FIG. 5B, 0.0.0.0 is newly assigned to the amplifier as a physical address by a CEC communication being stopped. This results in defining a second cluster (a newly added cluster) with the amplifier being a root. Consequently, in addition to the playback devices (devices 13 and 14), another playback device (a device 16) (having a physical address of 3.0.0.0) can be connected to the amplifier in the second cluster. As described above, a device can be newly added to an HDMI network by taking advantage of a stop of a CEC communication.

### 4. Typical Example of Information Processing System

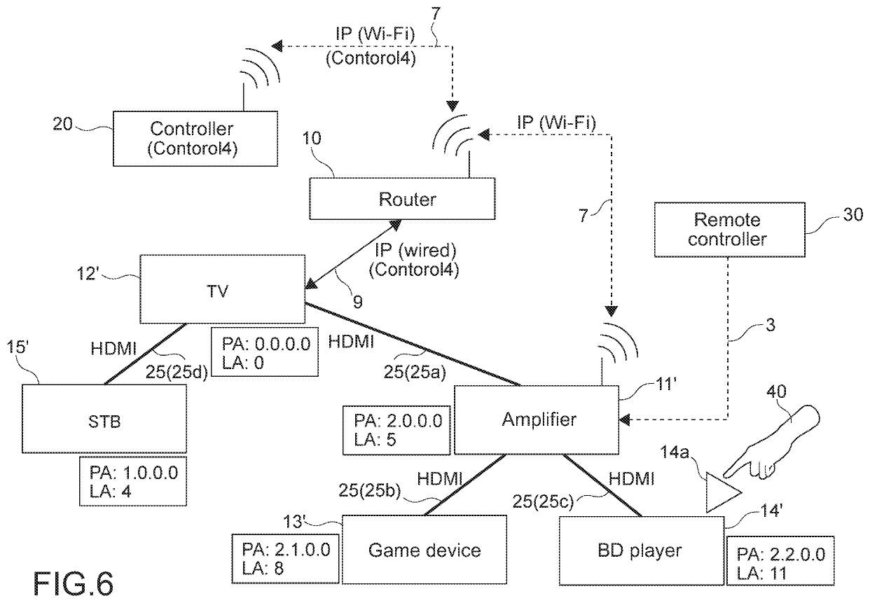

FIG. 6 is a block diagram of a typical example of the information processing system. The correspondence between the devices 11 to 15 illustrated in FIG. 1 and devices 11′ to 15′ illustrated in FIG. 6 is, for example, the following. The device 11 corresponds to an amplifier 11′, the device 12 corresponds to a TV 12′, the device 13 corresponds to a game device 13′, the device 14 corresponds to a Blu-ray (registered trademark) Disc (BD) player 14′, and the device 15 corresponds to a set-top box (STB) 15′. For example, a control system of Control4 is used as the controller 20. An HDMI cable 25 is used as the cable 5 described above.

In FIG. 6, a physical address (PA) and a logical address (LA) that are defined in HDMI are also depicted. The logical address is an address is assigned in an HDMI network representing the type of equipment (such as a TV, an amplifier, and a player), and is used in a command for a specific device.

When a control between devices is performed by the remote controller 30 on the amplifier 11′ via the infrared ray 3, there is a possibility that the amplifier 11′ will simultaneously receive a similar control from the controller 20 via IP. For example, when the TV 12′ or the amplifier 11′ is able to receive a control command between devices both via CEC and via IP, there is a possibility that a command conflict or the like will occur between the TV 12′ and the amplifier 11′. Thus, with respect to the two devices, there is a need to avoid a conflict between control commands received via these two different physical layers and to perform adjustment regarding the conflict.

Thus, as described above, for example, the TV 12′ and the amplifier 11′ mutually confirm through an HDMI cable 25a that both the TV 12′ and the amplifier 11′ support a control via IP. Then, as described above, the TV 12′ and the amplifier 11′ communicate a CEC command via IP by a method for, for example, performing encapsulation into an IP packet, the CEC command being a wire control command that is communicated through the HDMI cable 25a.

Regarding the confirmation method described above, for example, an HDMI system performs confirmation when the logical address of CEC is assigned, or a response indicating that a control via IP is supported may be received as system information when polling is performed.

The communication of a CEC command between the TV 12′ and the amplifier 11′ via IP makes it possible to easily avoid a conflict with a control command received from the controller 20 via IP and to perform adjustment regarding the conflict, using a scheduling/prioritization technique such as a typical Quality of Service (QoS).

Here, in the case of a wired connection such as a connection using HDMI, the topology (a connection form and a hierarchical structure) is clearly recognized by a user, compared to the case of a wireless connection. For example, a video of the BD player 14′ is of course expected to be displayed on the TV 12′ that is connected to the BD player 14′ using an HDMI cable 25c and the HDMI cable 25a. On the other hand, the use of a wireless LAN also makes it possible to establish a connection within a radius of about 30 m, that is, a connection beyond a roof, and in the LAN, all of the devices exist in a flat structure, not in a hierarchical structure. Thus, if the TV 12′ and the BD player 14′ are connected via wireless LAN, there will be a need to perform association every time a video is played back in the BD player 14′ such that the video is displayed on the TV 12′. In other words, the advantage of using a non-IP wired IF lies here. Thus, functions such as “One Touch Play” and “System Audio Mode” are desired to be implemented in essence by a communication of a CEC command via HDMI, not by a wireless communication.

However, when such a non-IP wired network and an IP network coexist, the occurrence of a conflict between these two control systems will be a problem, as described above.

Here, One Touch Play is a function that causes a video to be automatically output from the TV 12′ by a user 40 directly operating a playback button 14a provided to the BD player 14′. System Audio Mode is a function that causes sound to be played back (that performs switching such that sound is played back) by the amplifier 11′, not by the TV 12′. These functions correspond to one of the device linkage functions using CEC.

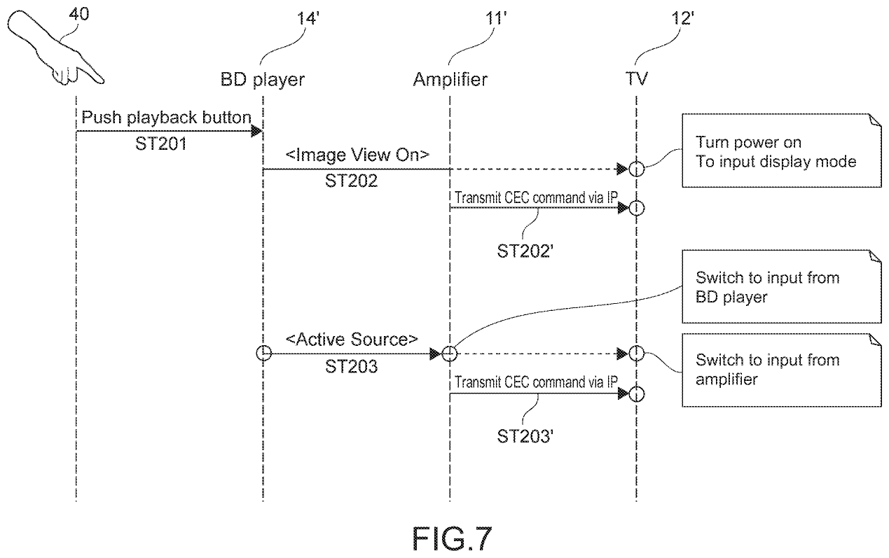

An operation performed when the function of One Touch Play described above has been applied to the present technology, is described below. FIG. 7 is a sequence diagram of the operation.

The user 40 operates (pushes) the playback button 14a provided on the BD player 14′ (ST201). Then, the BD player 14′ transmits a CEC command <Image View On> to the TV 12′ through the HDMI cable 25c and the amplifier 11′ (ST202). Here, the amplifier 11′ converts the CEC command <Image View On> into an IP packet and transmits it to the TV 12′ (ST202′).

The TV 12′ extracts a CEC command from the IP packet received via IP from the amplifier 11′, and recognizes that the extracted CEC command is an <Image View On> command issued to the TV 12′ itself. Then, the TV 12′ turns its own power on as necessary to perform switching to a mode of displaying a video input from an HDMI input, that is, a mode of displaying a video output by the BD player 14′.

Next, the BD player 14′ issues an CEC command <Active Source> to a device connected to an HDMI network, the CEC command <Active Source> indicating that a video is output from the BD player 14′ itself. The amplifier 11′ having received the CEC command <Active Source> sets the input on the BD player 14′ (for example, switches from the game device 13′ to the BD player 14′) (ST203).

Here, as in the case of Step 202′, the amplifier 11′ converts the CEC command <Active Source> into an IP packet and transmits it to the TV 12′ via IP (ST203′). The TV 12′ converts the received IP packet into a CEC command, and switches the video input to an input from the amplifier 11′, as instructed by the CEC command.

As described above, an application of a device linkage is provided using HDMI-CEC just by the user 40 operating (pushing) the playback button 14a of the BD player 14′, the device linkage being a process including switching the HDMI input, automatically turning on the power of the TV 12′, and automatically playing back a video on the TV 12′.

### 5. Modifications

The present technology is not limited to the embodiments described above, and may achieve other various embodiments.

For example, in the operation examples 1 and 2 respectively illustrated in FIGS. 3 and 4, the embodiment in which a wired IF communication is stopped to give priority to an IP communication has been described, but an embodiment in which an IP communication is stopped to give priority to a wired IF communication may also be adopted. For example, after the device 11 receives a command from the remote controller 30 in ST102, the device 11 may convert the received command into a wire control command, stop an IP communication, and transmit the wire control command to the device 12 via a wired IF.

In the respective embodiments described above, a Wi-Fi connection through the router 10 has been illustrated as an IP connection established between the devices 11 and 12. However, when HDMI is used as a wired IF, for example, a configuration in which a wired LAN is used for a portion of or all of the IP connection, a configuration in which HDMI Ethernet Channel (HEC) that is a mechanism of an IP connection using HDMI, is used, or a configuration in which the devices 11 and 12 are directly connected to each other using an IP, can also be adopted.

For example, in ST104 illustrated in FIGS. 3 and 4, nothing about a restart of a wired IF communication after the stop of the wired IF communication has been mentioned. For example, the device 11 may determine, after the stop of the wired IF communication, whether to restart the wired IF communication according to a specified condition. Examples of the specified condition include the case in which the controller 20 is disconnected from an IP network, or the case in which a user selects restarting.

In the case described above, the device 11 may inquire of the device 12 via IP whether the device 11 can transmit a wire control command to the device 12 via a wired IF. In this case, it is sufficient if the device 11 restarts communicating a wire control command to the device 12 via a wired IF when the device 11 receives, from the device 12, a response indicating that the device 12 can receive a wire control command via a wired IF.

Instead of the remote controller 30 described above, a controller may be used that transmits a command using light or a radio wave of a wavelength other than that of an infrared ray.

At least two of the features of the embodiments described above can also be combined.

Note that the present technology may also take the following configurations.

(1) An information processing device including:

a first communication section configured to perform communication using an Internet protocol (IP);

a second communication section configured to perform communication using a non-IP wired interface; and

a processing section configured to communicate a control command using one of the first communication section and the second communication section according to a specified condition, the first communication section being used to communicate an IP control command that is the control command using the IP, the second communication section being used to communicate a wire control command that is the control command with respect to a communication using the wired interface.

(2) The information processing device according to (1), in which

the processing section is configured to stop the communication performed using the second communication section when the processing section determines whether a second information processing device is able to receive the wire control command using the first communication section included in the second information processing device and has determined that the second information processing device is able to receive the wire control command using the first communication section included in the second information processing device, the second information processing device being connected to the information processing device through a wired network using the wired interface.

(3) The information processing device according to (2), in which

the processing section is configured to convert the wire control command into the IP control command, and to transmit, using the first communication section, the IP control command obtained by the conversion.

(4) The information processing device according to (2) or (3), in which

the processing section is configured to determine, in a state in which the communication of the wire control command that is performed using the second communication section has been stopped, whether a restart of the communication of the wire control command is possible.

(5) The information processing device according to (1), in which

the processing section is configured to communicate a control command using one of a communication performed using the first communication section and a communication performed using the second communication section, the one of the communications being selected by a user, the control command corresponding to the selected communication.

(6) The information processing device according to any one of (1) to (5), in which

the first communication section is configured to receive the IP control command issued by a controller that is connected to an IP network using the IP.

(7) The information processing device according to any one of (1) to (6), further including a command generator configured to generate the wire control command.
(8) The information processing device according to (7), in which

the command generator is configured to generate the wire control command according to a non-IP command issued by a remote controller.

(9) The information processing device according to (1), in which

the second communication section is configured to receive the wire control command issued by a third information processing device that is an information processing device other than the second information processing device.

(10) The information processing device according to (9), in which

the processing section is configured to transmit the received wire control command to the second information processing device using one of the first communication section and the second communication section.

(11) The information processing device according to any one of (1) to (10), in which

the second communication section is configured to transmit or receive an audio visual (AV) stream as primary data.

(12) An information processing method that is performed by an information processing device that includes a first communication section configured to perform communication using an Internet protocol (IP), and a second communication section configured to perform communication using a non-IP wired interface, the information processing method including

communicating a control command using one of the first communication section and the second communication section according to a specified condition, the first communication section being used to communicate an IP control command that is the control command using the IP, the second communication section being used to communicate a wire control command that is the control command with respect to a communication using the wired interface.

(13) An information processing system including:

a first information processing device; and

a second information processing device capable of communicating the first information processing device using an Internet protocol (IP) and connected to the first information processing device through a wired network using a non-IP wired interface, in which

the first information processing device includes
a first communication section configured to perform communication using the IP,
a second communication section configured to perform communication using the wired interface, and
a processing section configured to communicate a control command using one of the first communication section and the second communication section according to a specified condition, the first communication section being used to communicate an IP control command that is the control command using the IP, the second communication section being used to communicate a wire control command that is the control command with respect to a communication using the wired interface.

### REFERENCE SIGNS LIST

5 cable (for wired IF)
9 LAN cable
10 router
11 to 16 device
11′ amplifier
12′ TV
13′ game device
14′ BD player
15′ STB
20 controller
25 HDMI cable
30 remote controller
40 user

1. An information processing device comprising:
a first communication section configured to perform communication using an Internet protocol (IP);
a second communication section configured to perform communication using a non-IP wired interface; and
a processing section configured to communicate a control command using one of the first communication section and the second communication section according to a specified condition, the first communication section being used to communicate an IP control command that is the control command using the IP, the second communication section being used to communicate a wire control command that is the control command with respect to a communication using the wired interface.

2. The information processing device according to claim 1, wherein
the processing section is configured to stop the communication performed using the second communication section when the processing section determines whether a second information processing device is able to receive the wire control command using the first communication section included in the second information processing device and has determined that the second information processing device is able to receive the wire control command using the first communication section included in the second information processing device, the second information processing device being connected to the information processing device through a wired network using the wired interface.

3. The information processing device according to claim 2, wherein
the processing section is configured to convert the wire control command into the IP control command, and to transmit, using the first communication section, the IP control command obtained by the conversion.

4. The information processing device according to claim 2, wherein
the processing section is configured to determine, in a state in which the communication of the wire control command that is performed using the second communication section has been stopped, whether a restart of the communication of the wire control command is possible.

5. The information processing device according to claim 1, wherein
the processing section is configured to communicate a control command using one of a communication performed using the first communication section and a communication performed using the second communication section, the one of the communications being selected by a user, the control command corresponding to the selected communication.

6. The information processing device according to claim 1, wherein
the first communication section is configured to receive the IP control command issued by a controller that is connected to an IP network using the IP.

7. The information processing device according to claim 1, further comprising a command generator configured to generate the wire control command.

8. The information processing device according to claim 7, wherein
the command generator is configured to generate the wire control command according to a non-IP command issued by a remote controller.

9. The information processing device according to claim 1, wherein
the second communication section is configured to receive the wire control command issued by a third information processing device that is an information processing device other than the second information processing device.

10. The information processing device according to claim 9, wherein
the processing section is configured to transmit the received wire control command to the second information processing device using one of the first communication section and the second communication section.

11. The information processing device according to claim 1, wherein
the second communication section is configured to transmit or receive an audio visual (AV) stream as primary data.

12. An information processing method that is performed by an information processing device that includes a first communication section configured to perform communication using an Internet protocol (IP), and a second communication section configured to perform communication using a non-IP wired interface, the information processing method comprising
communicating a control command using one of the first communication section and the second communication section according to a specified condition, the first communication section being used to communicate an IP control command that is the control command using the IP, the second communication section being used to communicate a wire control command that is the control command with respect to a communication using the wired interface.

13. An information processing system comprising:
a first information processing device; and
a second information processing device capable of communicating the first information processing device using an Internet protocol (IP) and connected to the first information processing device through a wired network using a non-IP wired interface, wherein
the first information processing device includes
a first communication section configured to perform communication using the IP,
a second communication section configured to perform communication using the wired interface, and
a processing section configured to communicate a control command using one of the first communication section and the second communication section according to a specified condition, the first communication section being used to communicate an IP control command that is the control command using the IP, the second communication section being used to communicate a wire control command that is the control command with respect to a communication using the wired interface.
